(19) United States
(12) Patent Application Publication
(10) Pub. No.: US 2011/0247245 A1
(43) Pub. Date: Oct. 13, 2011

(54) Apparatus for Multi-Functional Snow Use

(76) Inventor: Quang Lam, Philadelphia, PA (US)

(21) Appl. No.: 12/720,844

(22) Filed: Mar. 10, 2010

(51) Int. Cl. B62B 15/00; E01H 5/02

(52) U.S. Cl. 37/241; 280/18

(57) ABSTRACT

An apparatus for multi-functional snow use. In a first orientation, the apparatus can be used to shovel snow, while in a second orientation, the apparatus can be used for recreational sledding. The apparatus is not reconfigured but rather simply reoriented depending on the apparatus' intended use. The apparatus has a substantially-planar base with first and second lengthwise-extending end edges, first and second widthwise-extending side edges, and top and bottom surfaces. Each side edge has at least one handle. A flange is fixed to the first end edge and oriented upwardly at a relief angle relative to the base. The flange may also include a hand grip. A blade is fixed to the second end edge.

### FIELD OF THE INVENTION

The present invention relates to an apparatus for multi-functional snow use. In particular, the invention relates to an apparatus that can be used to shovel snow in a first orientation and can be used for recreational sledding in a second orientation.

### BACKGROUND OF THE INVENTION

A wide variety of snow shovels are known in the prior art. A wide variety of recreational snow sleds are also known in the prior art. Known snow shovels are typically not used for sledding due to their size and specialized construction. Similarly, known recreational sleds are typically not used for shoveling snow due to their size and specialized construction. In order to save money and reduce the storage space needed for such seasonal items, it would be desirable to provide a single apparatus that can be used for both recreational sledding and for shoveling snow.

### SUMMARY OF THE INVENTION

The present invention comprises an apparatus for multi-functional snow use. In a first orientation, the apparatus can be used to shovel snow, while in a second orientation, the apparatus can be used for recreational sledding. The apparatus 10 is not reconfigured but rather simply reoriented depending on the apparatus' intended use.

The apparatus has a substantially-planar base with first and second lengthwise-extending end edges, first and second widthwise-extending side edges, and top and bottom surfaces. Each side edge has at least one handle. A flange is fixed to the first end edge and oriented upwardly at a relief angle relative to the base. The flange may also include a hand grip. A blade is fixed to the second end edge.

In a preferred embodiment, a flange is fixed to each of the side edges and is oriented upwardly at an angle relative to the base. Each side edge is formed in the side flanges. Alternatively, a plurality of handles is formed in each of the side flanges. Preferably, a handle is also formed in and proximate each widthwise periphery of the flange. A handle may also be formed in and proximate the widthwise periphery of the flange. Alternatively, the apparatus may include a pair of removable handles that engage the base or flange.

In a preferred embodiment, the blade comprises a tapered, second widthwise-extending end edge. The blade may include a metal reinforcement strip fixed to and extending along the second end edge.

In another embodiment, the apparatus includes a plurality of lengthwise-extending reinforcement ribs in the base. The ribs protrude outwardly from the bottom surface of the base.

In yet a further embodiment of the invention, the base has a lengthwise-extending, hull-shaped bottom surface. The hull shape is created by a central crease that extends along a substantial portion of the base and may further extend through the center of the first end flange.

### BRIEF DESCRIPTION OF THE DRAWINGS

FIG. 1 is a top plan view of an apparatus for multi-functional snow use in accordance with an embodiment of the invention;

FIG. 2 is a side elevation of the apparatus shown in FIG. 1;

FIG. 3 is an end elevation of the apparatus shown in FIG. 1;

FIG. 4 is an enlarged, fragmented, cross-sectional view of the blade at the second end of the apparatus shown in FIG. 1;

FIG. 4A is an enlarged, fragmented, cross-sectional view of an alternative blade at the second end of the apparatus shown in FIG. 1;

FIG. 4B is an enlarged, fragmented, cross-sectional view of yet another alternative blade at the second edge of the apparatus show in FIG. 1;

FIG. 5 is a top plan view of an apparatus for multi-functional snow use in accordance with another embodiment of the invention;

FIG. 6 is an end elevation of the apparatus shown in FIG. 5;

FIG. 7 is a top plan view of an apparatus for multi-functional snow use in accordance with a further embodiment of the invention;

FIG. 8 is an end elevation of the apparatus for multi-functional snow use shown in FIG. 7;

FIG. 9 is a top plan view of an apparatus for multi-functional snow use in accordance with yet another embodiment of the invention;

FIG. 10 is an end elevation of the apparatus for multi-functional snow use shown in FIG. 9; and,

FIG. 11 is a side elevation of the apparatus shown in two sequential steps plowing snow in accordance with a method of the invention.

### DETAILED DESCRIPTION OF PREFERRED EMBODIMENTS

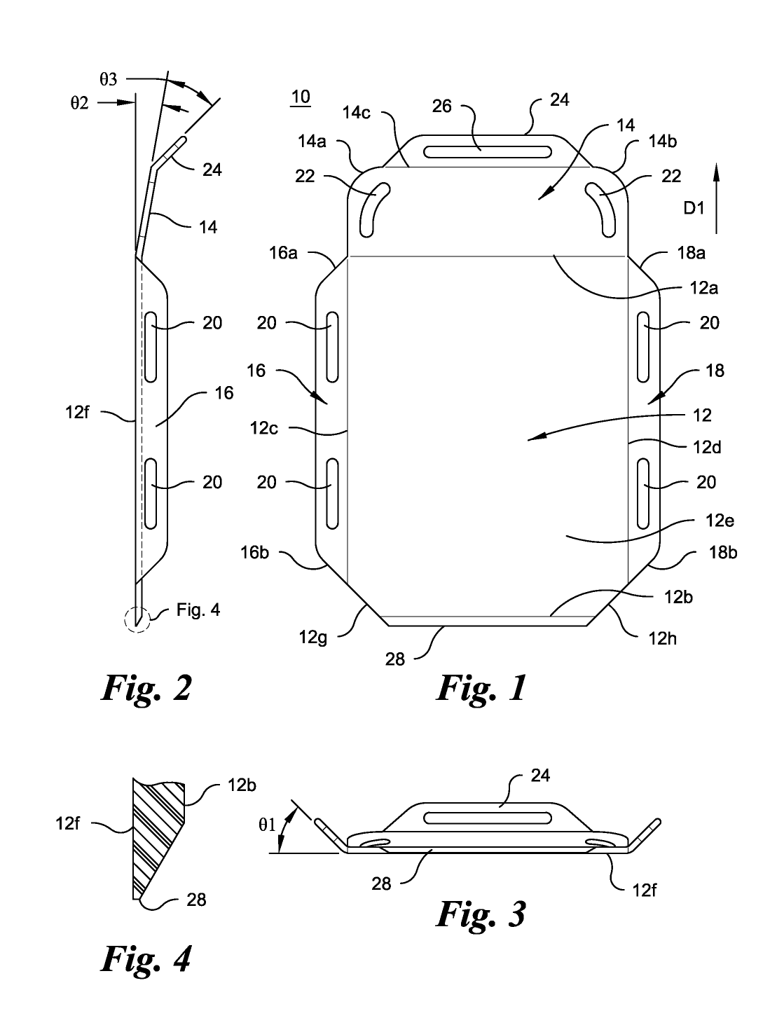

The apparatus for multi-functional snow use of the present invention is described below with reference to FIGS. 1-11, wherein like reference numerals are used throughout to designate like elements.

An apparatus for multi-functional snow use in accordance with a first embodiment is shown in FIGS. 1-4 and is designated generally by reference numeral 10. In a first orientation, the apparatus 10 can be used to shovel snow, while in a second orientation, the apparatus 10 can be used for recreational sledding. The apparatus 10 is not reconfigured but rather simply reoriented depending on the apparatus' intended use. For example, if the apparatus 10 will be used for sledding in the direction D1 shown in FIG. 1, the apparatus should be oriented in the direction shown in FIG. 1. However, if the apparatus will be used for removing snow in the direction D1 shown in FIG. 1, the apparatus 10 should be rotated 180 degrees about the plane of the page.

The apparatus 10 has a substantially-planar, rectangular base 12 made of a strong, rigid material such as rigid plastic or metal. The base has first 12a and second 12b widthwise-extending end edges, first 12c and second 12d lengthwise-extending side edges, and top 12e and bottom 12f surfaces. As best seen in FIGS. 2 and 3, flanges 14, 16, 18 extend from the first end edge 12a, first side edge 12c and second side edge 12d, respectively. In the embodiment shown in FIGS. 1-4, the flanges 14, 16, 18 comprise the same material and are integrally formed with the base 12 using known manufacturing methods.

In contrast with the rectangular shape of the base 12, the side flanges 12c, 12d have a trapezoidal shape with tapered ends 16a, 16b, 18a, 18b. Referring to FIG. 3, the side flanges 16, 18 are oriented upwardly at an angle theta (θ1) relative to the base 12. In the embodiment show in FIGS. 1-4, each side flange includes a pair of cutouts 20 approximating the size of a human hand, which allow the user to grasp the side flanges 16, 18 via the cutouts 20, especially when using the apparatus 10 as a sled. Preferably, the cutouts 20 are located proximate the ends of the side flanges so that both a fore and aft sled rider can easily grasp the apparatus when the apparatus is used for tandem sledding. The area of the side flanges 16, 18 surrounding the cutouts may optionally be thickened or coated with a high friction surface for improved gripping and strength.

As best seen in FIGS. 1 and 2, the first-end flange 14 has a generally rectangular shape with rounded distal (relative to the base 12) corners 14a, 14b. The first-end flange 14 is continuous with the width of the first end 12a of the base 12, and is oriented upwardly at an angle theta 2 (θ2) relative to the base, which angle should be great enough so that the first-end flange does not impinge the ground or snow when the apparatus is used as a sled. The first-end flange 14 has a pair of cutouts 22 approximating the size of a human hand, which allow the user to grasp the first-end flange 14 via the cutouts 20, especially when using the apparatus 10 as a shovel. Preferably, the cutouts 22 are located proximate the lengthwise-extending edges of the first-end flange 14 so that the user can exert the most lateral control of the apparatus 10. Similar to the side edge cutouts 20, the area of the first-end flange 14 surrounding the cutouts 22 may optionally be thickened or coated with a high friction surface for improved gripping and strength.

A handle 24 is fixed to the widthwise-extending, distal edge 14c of the first-end flange 14. In the embodiment shown in FIGS. 1-4, the handle comprises a flange fixed to and extending upwardly and an angle theta 3 (θ3) relative to the first-end flange 14. The handle 24 includes an elongate, widthwise-extending cutout 26 that is large enough so that the user can grasp the handle 24 with two hands. When used as a shovel, the handle 24 provides an alternative gripping portion compared to the side cutouts 22. When used as a sled, the central cutout 26 in the handle 24 provides an attachment point for a towing rope or an aperture for a storage hook. In this embodiment, the handle 24 is integrally formed with the first-end flange 14 using known manufacturing techniques.

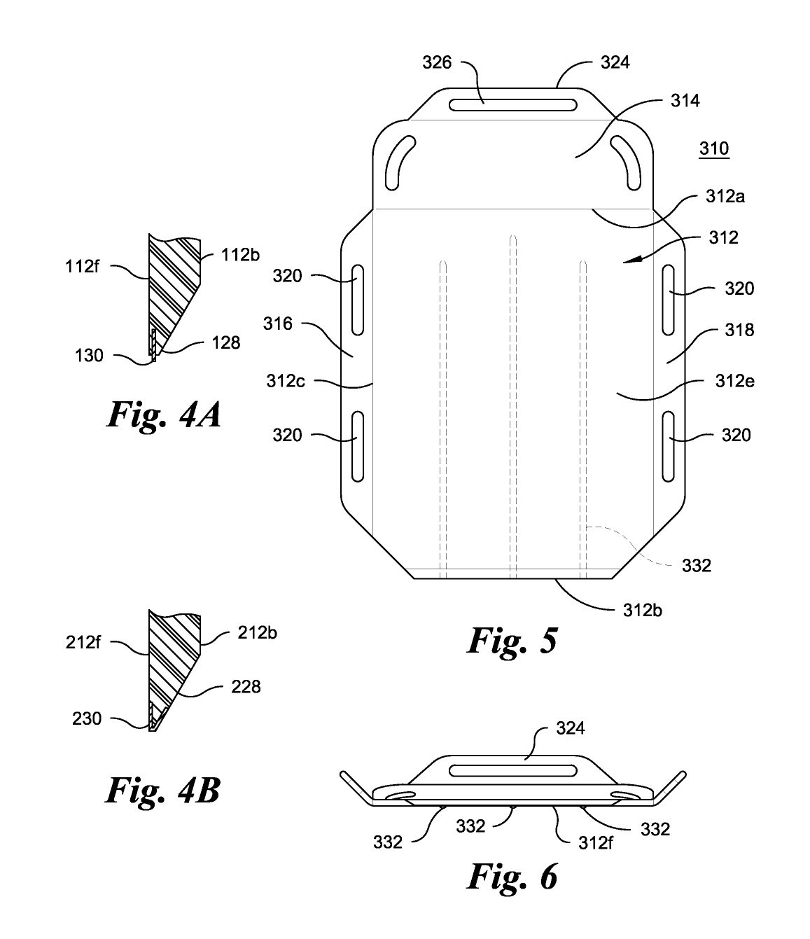

As best seen in FIGS. 1, 2 and 4, the second widthwise-extending end edge 12b is tapered to form a sharpened distal blade 28, which is useful for scraping snow from the ground surface when the apparatus is used as a shovel. In the embodiment shown in FIGS. 1-4, the blade 28 simply comprises a decreasing triangular taper in the edge of the base material itself. However, for increased lateral bending strength and wear resistance, the blade 28 of other preferred embodiments may include sacrificial strengthening strips such as shown in FIGS. 4a and 4b. For example, FIG. 4a shows the bottom 112f and blade 128 of the second widthwise-extending edge 112b of an alternative embodiment. In this embodiment, a metal strip 130 is embedded in the blade 128 and extends generally along the width of the second end edge 112b. FIG. 4b shows the bottom 212f and blade 228 of the second widthwise-extending edge 212b of another embodiment. In this embodiment, a metal channel 230 is installed over the blade 228 and extends generally along the width of the blade 228. Other forms of strengthened edges should be apparent to those of ordinary skill in the art.

Referring to FIG. 1, the corners 12g, 12h of the second end 12b are preferably tapered at a centrally-converging angle, which reduces the length of the blade 28 compared to the width of the base 12. The tapered corners 12g, 12h reduce the risk of injury associated with sharp, right-angle corners. Furthermore, in the shoveling mode, the tapered shape of the second end 12b allows the blade 28 to cut through snow and ice more easily. Alternatively, the corners 12g, 12h may be rounded.

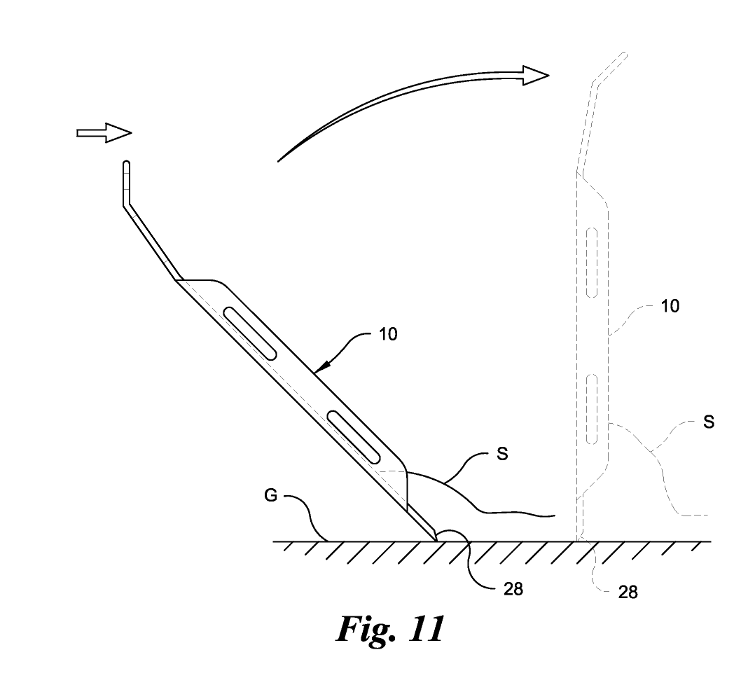

The apparatus 10 is multi-functional. In a first orientation shown in FIG. 1, the apparatus can be used for recreational sledding in the direction D1 in a manner similar to other recreational sleds. In the first orientation, a rider kneels, sits, or lies prone on the top side 12e of the base, grips either the front cutouts 20, 22 or the side cutouts 20, and slides along the snow covered surface. In the second orientation, the apparatus 10 can be used as a shovel for removing snow from the driveway, sidewalk or any other snow covered surface. In the second orientation, the user grips either the handle 24 or the sides of the first-end flange via the cutouts 26, 22, respectively, with the blade 28 pointing away from the user. The user then pushes the apparatus along the area of deposited snow such as, for example, the user's driveway or sidewalk. However, instead of lifting and throwing the snow “S” in the usual manner as with a conventional shovel, the user pushes (plows) the snow “S” to the perimeter of the ground area “G”, and then pivots the device about the blade 28 to push or wedge the snow “S” into a pile outside the periphery of the ground area “G” such as seen FIG. 11.

In a preferred embodiment, the apparatus 10 is integrally formed from a single piece of light-weight, rigid material such as wood, fiberglass, or hard plastic. The strength and thickness of the material should be sufficient to bear the weight of one or more riders or a load of wet snow, yet light enough so that a single person can easily carry the apparatus. The size of the apparatus may vary but may be, for example, about 3 to 4 feet long and about 2 to 3 feet wide. In a preferred embodiment, the apparatus has a length/width ratio shown in FIG. 1.

As best seen in FIG. 1, the first and second sides 12c, 12d are preferably parallel to each other and perpendicular to the first and second ends 12a, 12b. Alternatively, the first and second sides 12, 12d may be non-parallel to create a trapezoidal base, preferably converging in the direction extending from the second end to the first end.

Another embodiment of the invention is shown in FIGS. 5 and 6. In this embodiment, the apparatus 310 has generally the same shape and construction as the apparatus 10 shown in FIGS. 1-4, including a planar base 312, first end 312a, second end 312b, first side 312c, second side 312d, top side 312e, bottom side 312f, first-end flange 314, first and second side flanges 316, 318, side cutouts 320, handle 324 and cutout in the handle 326. However, in this embodiment, the base includes a plurality of lengthwise-extending reinforcement ribs 332. The ribs 332 may be integrally-formed with or affixed to the base 312. In either event, the ribs 332 preferably protrude from the bottom surface 312f and extend parallel to the first and second sides 312c, 312d. In addition to providing additional strength to the base 312, the ribs 332 help steer the apparatus when used in the sledding mode.

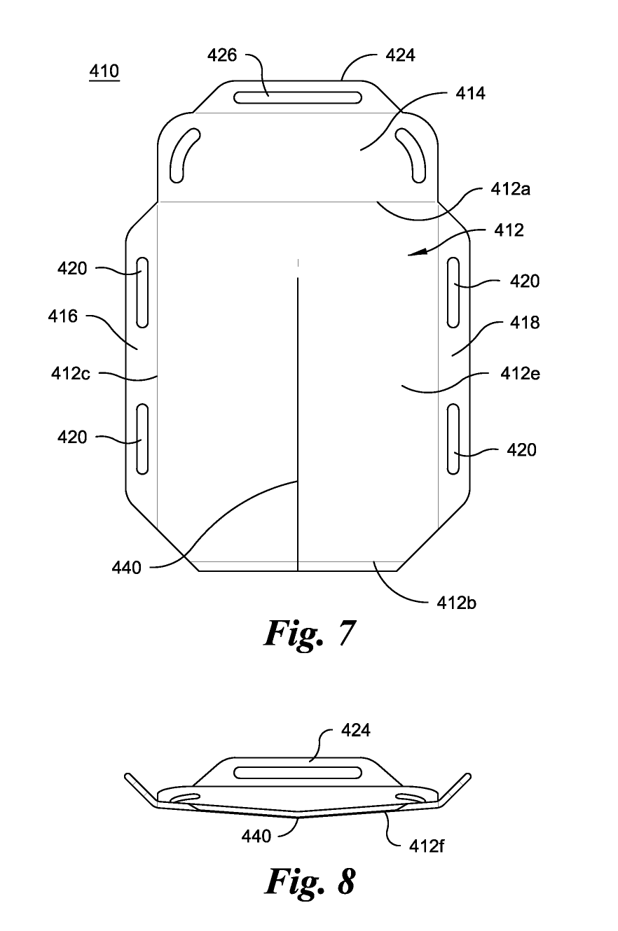

A further embodiment of the invention is shown in FIGS. 7 and 8. In this embodiment, the apparatus 410 has generally the same shape and construction as the apparatus 10 shown in FIGS. 1-4, including a base 412, first end 412a, second end 412b, first side 412c, second side 412d, top side 412e, bottom side 412f, first-end flange 414, first and second side flanges 416, 418, side cutouts 420, handle 424 and cutout in the handle 426. However, in this embodiment, the base 412 is not generally planar. Instead, the base 412 has a lengthwise extending crease 440 so that the cross-section of the base has a “V” or hull shape as best seen in FIG. 8. In the embodiment shown in FIGS. 7 and 8, the crease 440 extends from the second end to a position proximate, but short of, the first end 412a. However, the crease 440 may be extended the full length of the base 412 and may further extend through the center of the first end flange 414. In the sledding mode, the crease 440 helps steer the apparatus 410 and divert snow around the apparatus 410 similar to the hull of a ship. In the shoveling mode, the crease provides longitudinal strengthening of the base 412.

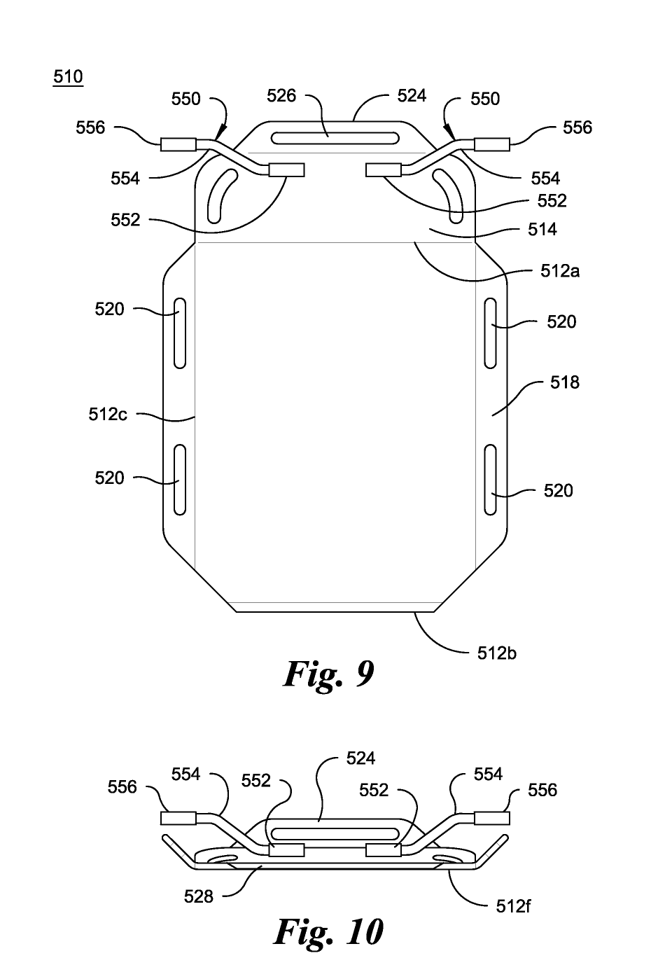

An additional embodiment of the invention is shown in FIGS. 9 and 10. In this embodiment, the apparatus 510 has generally the same shape and construction as the apparatus 10 shown in FIGS. 1-4, including a generally-planar base 512, first end 512a, second end 512b, first side 512c, second side 512d, top side 512e, bottom side 512f, first-end flange 514, first and second side flanges 516, 518, side cutouts 520, handle 524, cutout in the handle 526, and blade 528. However, in this embodiment, the apparatus 510 includes a plurality of laterally-extending handles 550 fixed to the first end flange 514. In this embodiment, each handle 550 includes an arm 554 having a hand grip 556 at one end. The other end of the arm is fixed in a socket 552, which is fixed to the first end flange 514. Alternatively, the sockets could be fixed to the base. The arms 554 may be either permanently or removably fixed in the sockets 552. In the sledding mode, the user may lay prone and grasp the handles 550 to steer the apparatus 510. In the shoveling mode, the user utilizes the handles 550 for greater laterally stability since the handles 550 preferably extend widthwise farther than the width of the apparatus 510.

While the principles of the invention have been described above in connection with specific embodiments, it is to be clearly understood that this description is made only by way of example and not as a limitation on the scope of the invention. For example, the individual features of the various embodiments described herein may be combined in different configurations without departing from the intended scope of the invention.

1. An apparatus for multi-functional snow use, comprising:
a) a base having first and second widthwise-extending end edges at opposed first and second ends of the apparatus, first and second lengthwise-extending side edges, and top and bottom surfaces;
b) a handle on each of said side edges;
c) a flange fixed to said first end edge and oriented upwardly at a relief angle relative to said base; and,
d) an elongate, straight blade fixed to said second end edge;
wherein said apparatus has a first orientation for use as a snow sled in which the first end edge is at the front of the apparatus and a second orientation for use as a snow shovel in which the second end edge is at the front of the apparatus, said orientations being changed by rotating the base 180 degrees.

2. The apparatus recited in claim 1, including a hand grip on said flange.

3. The apparatus recited in claim 1, including a flange fixed to each of said side edges and oriented upwardly at an angle relative to said base.

4. The apparatus recited in claim 3, wherein said handle is formed in said side flanges.

5. The apparatus recited in claim 4, including a plurality of handles formed in each of said side flanges.

6. The apparatus recited in claim 2, including a handle formed in and proximate each lengthwise periphery of said flange.

7. The apparatus recited in claim 6, including a handle formed in and proximate the widthwise periphery of said flange.

8. The apparatus recited in claim 2, including a pair of removable handles engaging said flange.

9. The apparatus recited in claim 1, wherein said blade comprises a tapered second end edge.

10. The apparatus recited in claim 9, wherein said blade includes metal reinforcement strip fixed to and along said second end edge.

11. The apparatus recited in claim 1, including a plurality of lengthwise-extending reinforcement ribs in said base.

12. The apparatus recited in claim 11, wherein said ribs protrude outwardly from the bottom surface of said base.

13. The apparatus recited in claim 1, when said base has a lengthwise-extending hull shaped bottom surface.
